(19) United States
(12) Patent Application Publication
(10) Pub. No.: US 2013/0227645 A1
(43) Pub. Date: Aug. 29, 2013

(54) TERMINAL AND METHOD FOR ACCESS POINT VERIFICATION

(71) Applicant: PANTECH CO., LTD., (US)

(72) Inventors: Jung Geon LIM, Seoul (KR); Mi Jung Kim, Seoul (KR)

(73) Assignee: PANTECH CO., LTD., Seoul (KR)

(21) Appl. No.: 13/711,980

(22) Filed: Dec. 12, 2012

(30) Foreign Application Priority Data
Feb. 29, 2012 (KR) 10-2012-0021485

(51) Int. Cl. H04L 29/06

(52) U.S. Cl. CPC H04L 63/10; H04L 63/101
USPC 726/3

(57) ABSTRACT

A terminal to determine a security status of an AP includes an AP retrieval unit to identify an AP connectable with the terminal, an AP determination unit to connect with the AP and determine whether the AP is vulnerable, and a controller to control the connection with the AP if the AP is determined to be vulnerable. A method for determining a security status of an AP with a terminal includes identifying a connectable AP, connecting the terminal with the AP, determining whether the AP is vulnerable, and controlling the connection with the AP if the AP is determined to be vulnerable.

### CROSS-REFERENCE TO RELATED APPLICATION

This application claims priority from and the benefit of Korean Patent Application No. 10-2012-0021485, filed on Feb. 29, 2012, which is hereby incorporated by reference for all purposes as if fully set forth herein.

### BACKGROUND

1. Field

Exemplary embodiments of the present invention relate to a system and method for determining security of an open access point (AP) and controlling connection to the AP based on its security setting.

2. Discussion of the Background

A mobile terminal is provided with various services offered by a server via data communication with the server. The mobile terminal may communicate with the server through an access point (AP), for example, a wireless router.

The mobile terminal is provided with various benefits, such as communication through use of wireless networks, such as wireless fidelity (Wi-Fi), due to communications with the server via the AP. The communication data transmitted and/or received by the mobile terminal may exposed to an environment in which the communicated data may be intercepted by one or more APs since the AP serves as a relay between the mobile terminal and the server. The AP may intercept data transmitted between the mobile terminal and the server may pass or deliver incomplete data between the terminal and the server. More specifically, the AP may pass or deliver modified data to the server or to the mobile terminal during communication with the mobile terminal or from the server.

Accordingly, data to be secured or sensitive information, such as personal information, may potentially be leaked while the mobile terminal communicates with the server through the AP.

Thus, there is a need for technology that may protect against or reduce a likelihood of data leakage.

### SUMMARY

Exemplary embodiments of the present invention provide a system and method for determining security of an open access point (AP) and controlling connection to the AP based on its security setting.

Additional features of the invention will be set forth in the description which follows, and in part will be apparent from the description, or may be learned by practice of the invention.

Exemplary embodiments of the present invention provide a terminal to determine a security status of an AP including an AP retrieval unit to identify an AP connectable with the terminal; an AP determination unit to connect with the AP and determine whether the AP is vulnerable; and a controller to control the connection with the AP if the AP is determined to be vulnerable.

Exemplary embodiments of the present invention provide a method for determining a security status of an AP with a terminal including identifying a connectable AP; connecting the terminal with the AP; determining whether the AP is vulnerable; and controlling the connection with the AP if the AP is determined to be vulnerable.

Exemplary embodiments of the present invention provide a terminal to determine a security status of an AP including an AP retrieval unit to identify an AP connectable with the terminal; a database to store a list of rouge APs; an AP determination unit to connect with the AP and determine whether the AP is vulnerable if information associated with the AP is included in the list of rouge APs; and a controller to terminate the connection with the AP if the AP is determined to be vulnerable.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 illustrates a configuration of a mobile system to perform Access Point (AP) verification according to an exemplary embodiment of the present invention.

FIG. 2 illustrates a configuration of a terminal to perform AP verification according to an exemplary embodiment of the present invention.

FIG. 3 illustrates an operation of a terminal to perform AP verification according to an exemplary embodiment of the present invention.

FIG. 4 illustrates an operation of a terminal to perform AP verification according to an exemplary embodiment of the present invention.

FIG. 5 is a flowchart illustrating a method for performing AP verification according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Further, it will be understood that when an element is referred to as being “connected to” another element, it can be directly connected to the other element, or intervening elements may be present.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

Hereinafter, a terminal to perform access point (AP) verification and a method for operating the terminal according to exemplary embodiments of the present invention will be described with reference to the accompanying drawings. The terminal to perform AP verification may be, for example, a mobile terminal, but is not limited thereto.

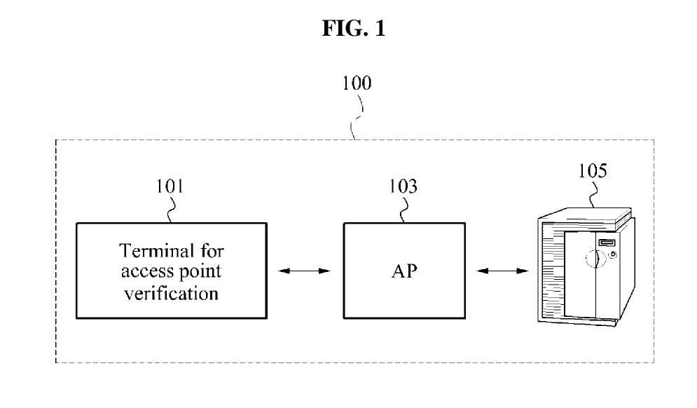

FIG. 1 illustrates a configuration of a mobile system to perform AP verification according to an exemplary embodiment of the present invention.

Referring to FIG. 1, a mobile system 100 includes a terminal 101, an AP 103, and a server 105.

The terminal 101 to perform AP verification may retrieve or identify an AP positioned in a defined area, which may support communication with the server 105. The terminal 101 may connect to the identified AP 103. More specifically, the terminal 101 may connect to the server 105 based on a request to connect to the AP 103. When the terminal 101 connects to the AP 103, the terminal 101 may verify or determine whether the AP 103 is a non-secured or a vulnerable AP.

As a result of verification, when the AP 103 is determined to be an AP that is not secured, such as a rogue AP, the terminal 101 may disconnect from the AP 103 or control connection to the AP 103 based on a selection of a user regarding or a condition whether to maintain connection to protect against or reduce the likelihood of data leakage. The terminal 101 may determine that the AP 103 is vulnerable when the terminal 101 fails to receive an encrypted communication signal or message, such as a response in hypertext transfer protocol over secure socket layer (HTTPS), from the AP 103. The terminal 101 may determine that the AP 103 is secure if the terminal 101 receives an encrypted communication signal or message. The terminal 101 may receive an encrypted communication signal or message, such as a response signal or message, in response to a transmission of a request for encrypted communication to the server 106 through the AP 103.

Further, the terminal 101 may determine that the AP 103 is vulnerable when a feedback response obtained from the AP 103 fails to satisfy a condition or instruction. For example, the terminal 101 may determine that the AP 103 is vulnerable when the terminal 101 is not disconnected from the AP 103 in response to a request for termination of connection with the AP 103.

The AP 103 may connect to the terminal 101 based on a request for connection transmitted from the terminal 101. The AP 103 may relay communication between the terminal 101 and the server 105.

The server 105 may communicate with the terminal 101 through the AP 103. Here, the server 105 may provide one or more services to the AP 103 through the Internet or a network connection.

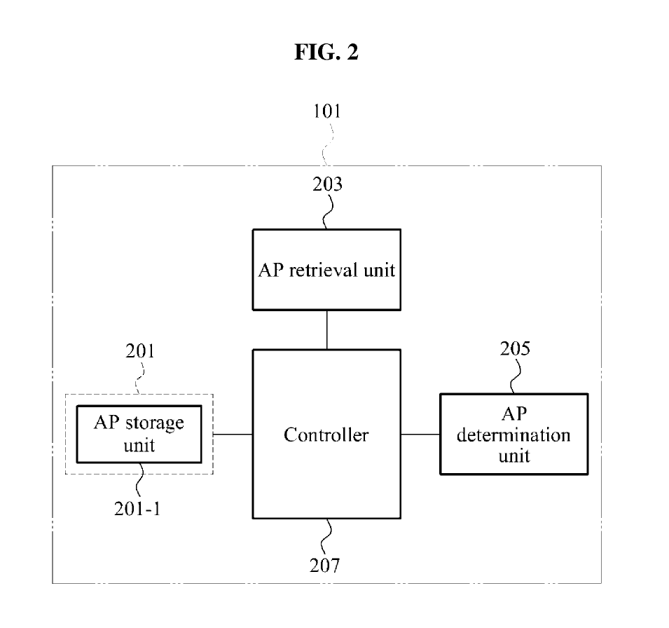

FIG. 2 illustrates a configuration of a terminal to perform AP verification according to an exemplary embodiment of the present invention.

Referring to FIG. 2, the terminal 101 includes a database 201, an AP retrieval unit 203, an AP determination unit 205, and a controller 207.

The database 201 includes an AP storage unit 201-1 to store information about one or more APs, which may include a record or history of previous connection(s) to the terminal 101 and information of whether the respective APs are or have been verified to be secure. However, aspects of the invention are not limited thereto, such that the AP storage unit 201-1 may store information of APs, including security information, that are currently connected to a terminal. Further, the security information of a terminal may be provided to the AP storage unit 201-1 in advance without a previous connection to the respective AP. The AP storage unit 201-1 may store a list of normal or secure APs, such as an AP which may prevent or protect against data leakage. The list of secure APs may also include address information of one or more secure APs.

The database 201 may further include a rogue AP storage unit (not shown), which may store information about one or more APs which has a record or history of connection to the terminal 101 and information of whether the respective APs are or have been vulnerable. The rogue AP storage unit may store a list of rogue APs, such as an AP that may possibly allow data leakage. The list of rouge APs may include address information of one or more rouge APs.

Further, the database 201 may further include a personal information unit storing personal information and/or other sensitive information. The personal information unit may store, without limitation, personal information for a website, such as, a user identification (ID), a password, a resident registration number, a social security number, financial account information, and the like.

The AP retrieval unit 203 may identify or retrieve a connectable AP based on a position of the terminal. The AP retrieval unit 203 may retrieve an AP, which may be positioned in a defined area based on the position of the terminal and may support communication with the server. Further, when a plurality of APs is retrieved, the AP retrieval unit 203 may provide a list of APs arranged according to a preset criterion, for example, intensity of a reception signal, prior connectivity to the APs, a number of prior connections to the APs, relative distances of the APs, and the like.

When receiving a request for connection to a particular AP among the retrieved APs, for example, by inputting a selection of the particular AP provided on the AP list, the AP determination unit 205 may connect to the particular AP and may determine whether security information of the particular AP is stored in the AP storage unit 201-1. When the security information of the particular AP is absent, such as when the particular AP is being connected to the respective terminal for the first time, the AP determination unit 205 may determine security of the AP.

In determination of the security information of the respective AP, the AP determination unit 205 may obtain address information of the connected AP and confirm whether the AP is secure using the obtained address information. In further detail, when the obtained address information on the AP is retrieved from the normal or secure AP list in the AP storage unit, the AP determination unit 205 may confirm or determine that the connected AP is secure. When the obtained address information on the AP is retrieved from the rogue AP list in the rogue AP storage unit, the AP determination unit 205 may confirm or determine that the connected AP may not be secure and may be vulnerable. Accordingly, when a record of connection to the AP exists, the address information on the AP may be retrieved from the rogue AP list or the normal AP list, so that the AP determination unit 205 may confirm or determine security of the AP based on a retrieval result.

When the AP is absent in the AP storage unit 201-1, or the address information on the particular AP is not included in the rogue AP list or the normal AP list, such as when the AP is connected to the terminal for the first time, the AP determination unit 205 may verify or determine security of the AP through various methods. The security verification methods may include, without limitation, (i) AP security verification using encrypted communication response method, and (ii) AP security verification using feedback response method. The enumerated methods may be described in more detail below.

The security verification method for performing (i) AP security verification using encrypted communication response will be discussed in more detail below.

The AP determination unit 205 may confirm or determine that the AP is vulnerable when an encrypted communication response from the AP fails to be received. More specifically, the AP determination unit 205 may determine that the AP is vulnerable when an encrypted communication response from the AP fails to be received in connection with transmission of a request for encrypted communication to the server through the AP. When an encrypted communication response from the AP fails to be received, the AP determination unit 205 may re-send a request for encrypted communication to the server a preset number of times.

For example, when sending personal information stored in the personal information unit, the AP determination unit 205 may determine whether an encrypted communication response is received from the server through the particular AP. When an encrypted communication response from the particular AP fails to be received, the AP determination unit 205 re-requests encrypted communication to the particular AP. When an encrypted communication response from the particular AP fails to be received after a reference number of attempts, then the AP determination unit 205 may determine that the particular AP may be vulnerable.

More specifically, after transmitting personal information through a web page provided in a Hypertext Transfer Protocol (HTTP) format to the particular AP, when a response webpage provided in a Hypertext Transfer Protocol over Secure Socket Layer (HTTPS) format fails to be received from the particular AP, the AP determination unit 205 may determine that the particular AP is vulnerable. Personal information may include, without limitation, an ID, a password, a resident registration number, a social security number, financial account information, and the like.

The security verification method for performing (ii) AP security verification using feedback response will be discussed in more detail below.

The AP determination unit 205 may determine that the particular AP is vulnerable when feedback received in response to an instruction transmitted to the particular AP fails to provide a satisfactory response. The AP determination unit 205 may determine that the particular AP is vulnerable when the feedback received indicates that the terminal 101 is not disconnected from the AP, for example, an instruction to terminate connection. The feedback indicating a connection status of the terminal 101 may be obtained from the AP after transmitting an instruction to the AP. The AP determination unit 205 may communicate with the AP based on Secure Socket Layer (SSL). By way of example, the AP determination unit 205 may send an instruction to terminate connection by transmitting an Alert protocol message in which ‘Level’ and ‘Description’ fields in Record Layer of SSL are written in ‘2’ and ‘0,’ respectively, to the AP.

The controller 207 may break the connection to the particular AP when the AP is determined to be vulnerable. Further, the controller 207 may make, or update, a rogue AP list using the address information on the particular AP, such as, a media access control (MAC) address or Service Set Identifier (SSID), and store the rogue AP list in the rogue AP storage unit of the database 201. When the particular AP is determined to be secure, the controller 207 may maintain the connection to the AP and may add information on the AP to the AP storage unit 201-1. More specifically, when the AP is secure, the controller 207 may make, or update, a normal or secure AP list using the address information of the AP and store the normal or secure AP list in the AP storage unit 201-1 of the database 201.

Further, even though the particular AP may be determined to be vulnerable, when communication data with the AP is unrelated to personal information or other sensitive information, the controller 207 may maintain the connection to the particular AP. Further, when the data that is being sent or communicated with the AP is determined not to be sensitive, the AP determination unit 205 may determine that the AP is not vulnerable. The AP determination unit 205 may determine that the AP is not vulnerable or secure at least during the time non-personal or non-sensitive information are being communicated. The controller 207 may provide an input field related to maintaining the connection to the AP on a screen along with a warning message about use of the AP. When the input field to maintain the connection is selected, the controller 207 may maintain the connection to the AP. However, aspects of the invention are not limited thereto, such that the controller 207 may maintain the connection to the AP automatically based on a condition or based on the determination of the data type being communicated.

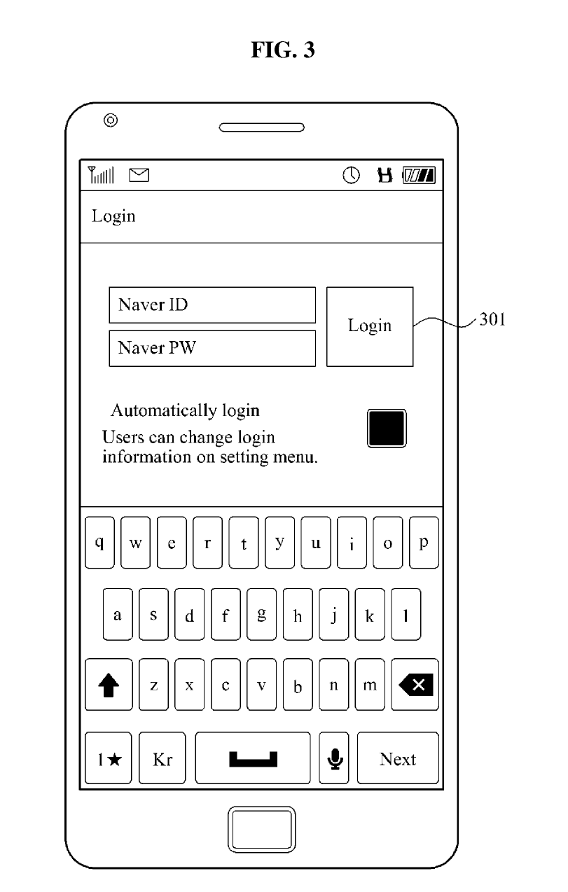

FIG. 3 illustrates an operation of a terminal to perform AP verification according to an exemplary embodiment of the present invention.

Referring to FIG. 3, the terminal 101 may determine security of an AP, and may break connection of the terminal to the AP when the AP is determined to be vulnerable or unsecured.

For example, the terminal 101 may activate a web page in a HTTP format and may obtain a service offered by a server from the AP through the activated web page. When an event of transmitting personal information in relation to the web page occurs, and when a web page in HTTPS format fails to be received from the AP, the terminal 101 may confirm that the AP is vulnerable or unsecured and may break the connection to the AP. The event of transmitting personal information may include a login event with a completed log in screen 301 including a user ID and password. More specifically, when a web page in HTTP format, but not a web page in HTTPS format, is received from the AP, the terminal 101 may break the connection to the AP. Accordingly, since a web page in HTTP format may not support encrypted communication, the terminal 101 may be restricted or prevented from transmitting personal information not encrypted to the AP.

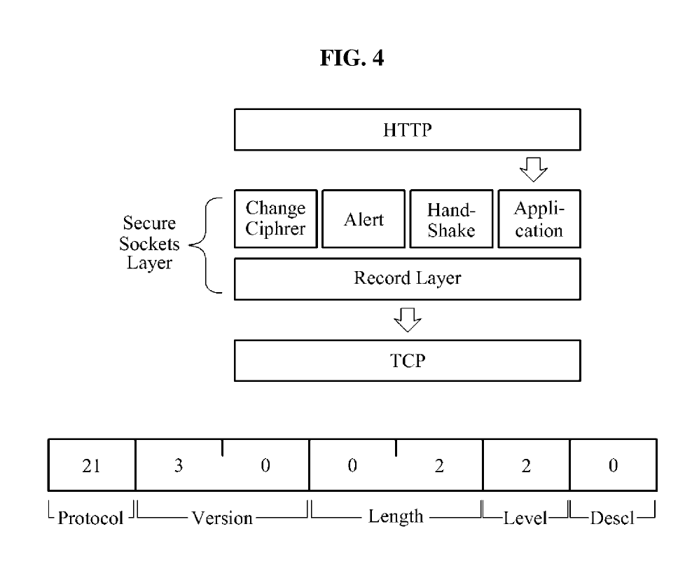

FIG. 4 illustrates an operation of a terminal to perform AP verification according to an exemplary embodiment of the present invention.

Referring to FIG. 4, the terminal 101 may determine security of a connected AP, and may break a connection to the AP when the AP is determined to be vulnerable or unsecured.

The terminal 101 may communicate with the AP based on SSL and may send an instruction to terminate the connection to the AP. The SSL may operate between Application Layers, such as HTTP and a Transport Layer (e.g., TCP), and be formed of at least one of Change Cipher, Alert, Handshake, and Record Layer protocols.

More specifically, the terminal 101 may send an instruction to terminate connection with the AP using the Record Layer of SSL. By way of example, the terminal 101 may transmit to the AP a message in which ‘Protocol,’ ‘Version,’ ‘Length,’ ‘Level’ and ‘Description’ fields of Record Layer are written to have values of ‘21,’ ‘30,’ ‘02,’ ‘2’ and ‘0,’ respectively. Here, the ‘Protocol’ of ‘21’ may denote an Alert protocol message, the ‘Version’ of ‘30’ may denote a version of 3.0, the ‘Length’ of ‘02’ may denote a length of 2, and the last two fields (‘Level’ and ‘Description’) may denote content of Alert protocol. Further, the ‘Level’ of ‘2’ may be an Alert level, which may denote, for example, that a termination of a connection may not necessary even though a problem exists. Other values of the ‘Level’ field may denote that a termination of a connection is necessary because a problem exists, or that a termination of connection is necessary without respect to an existence of a problem. The ‘Description’ of ‘0’ may denote reporting termination of a connection to the other party.

The terminal for AP verification may determine that the AP is vulnerable or unsecured when a feedback signal indicating that the terminal is not disconnected from the AP is received from the AP after sending an instruction signal to terminate connection to the AP.

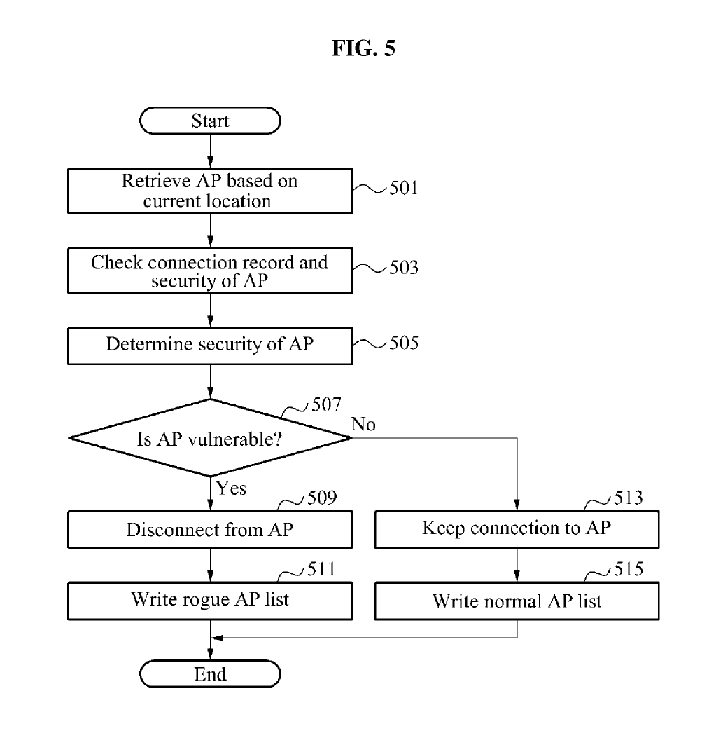

FIG. 5 is a flowchart illustrating a method for performing AP verification according to an exemplary embodiment of the present invention. Here, a terminal to perform AP verification may store information on a first AP, which may have a record of previous connection to the terminal and may be verified to be secure in the AP storage unit. The terminal may also store information on a second AP, which may have a record of previous connection to the terminal and verified to be vulnerable in the rogue AP storage unit.

Referring to FIG. 5, in operation 501, the terminal may retrieve a connectable AP based on a position of the terminal. More specifically, the terminal may search for an AP positioned in a defined area based on the position of the terminal, and the AP may support communication with a server. Here, when a plurality of APs is retrieved, the terminal may provide a list of APs arranged based on a preset criterion, such as, an intensity of a reception signal. The list of APs may be provided on a screen of the terminal.

In operation 503, when a request for connection to a particular AP among the retrieved APs is received, the terminal may connect to the particular AP and may determine whether the particular AP is an AP stored in an AP storage unit to confirm or determine a connection record and security status of the AP.

As an example, the terminal may determine that the particular AP is secure and may maintain a connection to the AP when information of the AP is determined to be stored in the AP storage unit, more specifically a normal or secure AP storage unit of the AP storage unit. The secure AP storage unit may store information of APs that may have been previously connected to the terminal and determined to be secured or not vulnerable. Further, the terminal may further determine that the particular AP is vulnerable and may break connection to the AP when information of the AP is determined to be stored in a rogue AP storage unit of the AP storage unit. The terminal may obtain address information of the connected particular AP, and may determine that the AP is secure when the obtained address information on the AP is retrieved from the normal or secure AP list in the AP storage unit. When the obtained address information on the AP is retrieved from the rogue AP list in the rogue AP storage unit, the terminal may determine that the connected AP is vulnerable.

In operation 505, when the particular AP is determined not to be stored in the AP storage unit, the terminal may verify or determine security status of the AP through other methods. Further, when the address information of the particular AP is determined not to be included in the rouge AP list or the normal AP list, such as when the AP is connected for the first time, the terminal may determine security of the AP using other methods.

The terminal may confirm or determine that the AP is vulnerable when an encrypted communication response from the AP fails to be received. More specifically, the terminal may determine that the AP is vulnerable when an encrypted communication response fails to be received from the AP in response to a request for encrypted communication that was transmitted to the server through the AP. To send personal information stored in the personal information unit, the terminal may determine whether an encrypted communication response is received from the server through the particular AP. When an encrypted communication response fails to be received from the particular AP, the terminal may retransmit the request for the encrypted communication from the particular AP. When an encrypted communication response from the particular AP fails to be received, then the terminal for AP verification may determine that the particular AP is vulnerable.

More specifically, after transmitting personal information via a web page in a HTTP format to the particular AP, when a webpage in a HTTPS format fails to be received from the particular AP, the terminal may determine that the particular AP is vulnerable.

Further, the terminal may determine that the particular AP is vulnerable when a feedback obtained from the AP, which may be received in response to an instruction transmitted to the particular AP, fails to satisfy a response corresponding to the instruction. For example, the terminal may determine that the particular AP is vulnerable when the terminal receives a feedback indicating that the terminal is not disconnected from the AP after transmitting an instruction to the AP, such as, an instruction to terminate the connection. Further, the terminal may communicate with the AP based on SSL. For example, the terminal may send an instruction to terminate a connection by transmitting an Alert protocol message in which ‘Level’ and ‘Description’ fields in Record Layer of SSL are written in ‘2’ and ‘0,’ respectively, to the AP.

When the particular AP is determined to be vulnerable in operation 507, the terminal disconnects from the AP in operation 509. However aspects of the invention are not limited thereto, such that even though the particular AP is determined to be vulnerable, when communication data with the AP is determined not to be related to personal information or other sensitive information, the terminal may maintain connection to the AP.

In operation 511, the terminal may make a rogue AP list using address information of the AP, such as an MAC address or SSID, and may store the list of rogue APs in the rogue AP storage unit of the database. However, aspects of the invention are not limited thereto, such that other information may be captured in the rogue AP list, including related hardware information.

When the AP is determined to be secure in operation 507, the terminal may maintain connection to the AP in operation 513.

In operation 515, the terminal may make a normal AP list using the address information on the AP and may store the normal AP list in the AP storage unit of the database 201.

According to exemplary embodiments of the present invention, when an AP supporting communication with a server is determined or verified as being vulnerable or unsecure, a terminal may be disconnected from the AP to prevent or reduce a likelihood of data leakage. However, aspects of the invention are not limited thereto, such that even if the respective AP is determined to be vulnerable, if the data being communicated does not include sensitive information, the connection to the respective AP may be maintained.

Further, according to exemplary embodiments of the present invention, when an AP supporting communication with a server is determined or verified as being vulnerable or unsecure, a terminal may update a list of rogue APs in a database to include the AP, thereby identifying security of an AP to which a connection may subsequently be made.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media, such as hard disks, floppy disks, and magnetic tape; optical media, such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

As described above, according exemplary embodiments of the present invention, when security information of an AP supporting communication with a server is not verified or verified as being unsecure, such as a rogue AP that is vulnerable, a system and method for access point verification may break a connection to the AP to prevent or reduce a likelihood of data leakage.

Further, when an AP supporting communication with a server is not verified as being secure, a system and method for access point verification may update a list of rogue APs in a database to include the AP, thereby easily identifying security of an AP to which a connection may subsequently be made.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed:

1. A terminal to determine a security status of an access point (AP), comprising:
an AP retrieval unit to identify an AP connectable with the terminal;
an AP determination unit to connect with the AP and determine whether the AP is vulnerable; and
a controller to control the connection with the AP if the AP is determined to be vulnerable.

2. The terminal of claim 1, wherein the AP retrieval unit identifies the AP connectable with the terminal based on a position of the terminal.

3. The terminal of claim 1, further comprising:
a database to store at least one of a list of secure APs and a list of rouge APs,
wherein if information associated with the AP is included in the list of secure APs, the AP is determined to be secure, and
if information associated with the AP is included in the list of rouge APs, the AP is determined to be vulnerable.

4. The terminal of claim 1, wherein the controller terminates the connection to the AP if the AP is determined to be vulnerable.

5. The terminal of claim 1, wherein the controller maintains the connection to the AP if the data communicated through the AP is determined to be non-sensitive information.

6. The terminal of claim 1, wherein the AP determination unit transmits a request to receive an encrypted communication response through the AP, and determines that the AP is vulnerable if the encrypted communication response from the AP fails to be received.

7. The terminal of claim 1, wherein the AP determination unit transmits a request to receive an encrypted communication response through the AP, and retransmits the request a reference number of times if the encrypted communication response from the AP fails to be received.

8. The terminal of claim 1, wherein the AP determination unit determines that AP is vulnerable if a feedback received in response to an instruction transmitted to the AP indicates that the AP failed to provide a satisfactory response.

9. The terminal of claim 3, wherein the controller updates the rouge list if the AP determination unit determines the AP to be vulnerable, and updates the secure list if the AP determination unit determines the AP to be secure.

10. The terminal of claim 1, further comprising a personal information unit to store personal information, the personal information comprising at least one of a user identification (ID), a password, a resident registration number, a social security number, and financial account information.

11. A method for determining a security status of an access point (AP) with a terminal, comprising:
identifying a connectable AP;
connecting the terminal with the AP;
determining whether the AP is vulnerable; and
controlling the connection with the AP if the AP is determined to be vulnerable.

12. The method of claim 11, wherein the AP connectable with the terminal is identified based on a position of the terminal.

13. The method of claim 11, wherein the AP is determined to be secure if information associated with the AP is included in a list of secure APs stored in the terminal, and wherein the AP is determined to be vulnerable if information associated with the AP is included in a list of rouge APs stored in the terminal.

14. The method of claim 11, wherein the controlling comprises terminating the connection to the AP if the AP is determined to be vulnerable.

15. The method of claim 11, wherein the controlling comprises maintaining the connection to the AP if the data communicated through the AP is determined to be non-sensitive information.

16. The method of claim 11, wherein the determining comprises transmitting a request for an encrypted communication response through the AP, and determining that the AP is vulnerable if the encrypted communication response from the AP fails to be received.

17. The method of claim 11, wherein the determining comprises transmitting a request for an encrypted communication response through the AP, and retransmitting the request for a reference number of times if the encrypted communication response from the AP fails to be received.

18. The method of claim 11, wherein AP is determined to be vulnerable if a feedback received in response to an instruction transmitted to the AP indicates that the AP failed to provide a satisfactory response.

19. The method of claim 13, further comprising updating the rouge list if the AP is determined to be vulnerable, and updating the secure list if the AP is determined to be secure.

20. A terminal to determine a security status of an access point (AP), comprising:
an AP retrieval unit to identify an AP connectable with the terminal;
a database to store a list of rouge APs;
an AP determination unit to connect with the AP and determine whether the AP is vulnerable if information associated with the AP is included in the list of rouge APs; and
a controller to terminate the connection with the AP if the AP is determined to be vulnerable.
